(19) United States
(12) Patent Application Publication
(10) Pub. No.: US 2021/0334729 A1
(43) Pub. Date: Oct. 28, 2021

(54) HUMAN RESOURCES PERFORMANCE EVALUATION USING ENHANCED ARTIFICIAL NEURON NETWORK AND SIGMOID LOGISTICS

(71) Applicant: Dell Products L. P., Round Rock, TX (US)

(72) Inventors: James S. Watt, Jr., Austin, TX (US); Parminder Singh Sethi, Ludhiana (IN); Hung The Dinh, Austin, TX (US); Ramu Kannappan, Frisco, TX (US)

(21) Appl. No.: 16/855,628

(22) Filed: Apr. 22, 2020

(51) Int. Cl. G06Q 10/06; G06N 3/08

(52) U.S. Cl. CPC G06Q 10/06398; G06N 3/08

(57) ABSTRACT

In some examples, a computing device may gather data associated with activities performed by individuals from multiple locations (e.g., code repositories). The computing device may determine data gathered by a data monitor application at individual locations of the multiple locations over a predetermined amount of time. The computing device may filter, based on criteria, the gathered data and perform an analysis of the filtered data using a machine learning algorithm (e.g., an artificial neural network and a logistic sigmoid). The criteria may be selected based at least in part on a job function associated with the particular individual. The machine learning algorithm may create a human resource evaluation of a particular individual of the plurality of individuals recommending an increase in salary, a bonus, or a promotion. The human resources evaluation may include a probability that the particular individual will leave a current job in the organization.

### BACKGROUND OF THE INVENTION

### Field of the Invention

This invention relates generally to performance evaluation of individuals in a corporate setting and more particularly to using machine learning to create the performance evaluation.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Evaluating the performance of individuals in an organization involves ranking individual contributors based on their corresponding level (also called job grade or job function), and then adjusting salaries and bonuses, if applicable, accordingly. Stack ranking is performed by the management roles within the organization and in many implementations is prone to several human flaws. For example, managers may over-value interpersonal skills or ‘face time’ by making decisions on stack rankings based on conversational or presentational skills rather than delivery. This is especially a problem in organizations where delivery cannot be accurately quantified. This may encourage employees to favor socialization and ‘cronyism’ style behaviors rather than focusing on delivering value for the company.

### SUMMARY OF THE INVENTION

This Summary provides a simplified form of concepts that are further described below in the Detailed Description. This Summary is not intended to identify key or essential features and should therefore not be used for determining or limiting the scope of the claimed subject matter.

As an example, a computing device may gather data from multiple locations. The data may be associated with activities performed by individuals in an organization (e.g., software developers in a development team). For example, the multiple locations may include locations that host a code repository that provides version control, project management, and the like. The computing device may determine (e.g., receive or retrieve) data gathered by a data monitor application at individual locations of the multiple locations over a predetermined amount of time. The computing device may filter, based on criteria, the gathered data to create filtered data and perform an analysis of the filtered data using a machine learning algorithm (e.g., an artificial neural network and a logistic sigmoid function). For example, the criteria may be selected based at least in part on a job function associated with the particular individual and may include, for the particular individual, how many lines of code are committed, a difference between a deadline associated with the code and a time the code was committed, how many issues are caused by the code, an amount time taken to resolve each issue caused by the code, how frequently the code is committed to a master branch, how many builds are completed, a success rate of completed builds, a percentage of code the particular individual contributed to a master branch, and a success rate of each commit. The machine learning algorithm may create a human resource evaluation of a particular individual of the plurality of individuals. For example, the human resources evaluation may include a compensation recommendation, such as, for example, to provide an increase in salary, provide a bonus, or provide a promotion. The human resources evaluation may include a probability that the particular individual will leave a current job in the organization.

### BRIEF DESCRIPTION OF THE DRAWINGS

A more complete understanding of the present disclosure may be obtained by reference to the following Detailed Description when taken in conjunction with the accompanying Drawings. In the figures, the left-most digit(s) of a reference number identifies the figure in which the reference number first appears. The same reference numbers in different figures indicate similar or identical items.

FIG. 1 is a block diagram of a system that includes a manager device that uses machine learning to evaluate a performance of individual developers, according to some embodiments.

FIG. 2 is a block diagram of a system to process gathered data using an artificial neural network and logistic sigmoid to create a performance evaluation, according to some embodiments.

FIG. 3 is a flowchart of a process that includes performing an analysis of metrics and weights using an artificial neural network, according to some embodiments.

FIG. 4 illustrates an example configuration of a computing device that can be used to implement the systems and techniques described herein.

### DETAILED DESCRIPTION

For purposes of this disclosure, an information handling system (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or video display. The information handling system may also include one or more buses operable to transmit communications between the various hardware components.

The systems and techniques described herein enable a computing device (e.g., an IHS) to use machine learning to input data associated with individuals (e.g., software developers, support technicians, documentation writers, software production people, and the like) and output an evaluation of the individuals. For example, the evaluation may be a fractional number between 0 and 1 (e.g., 0.0 represents poor performance, 0.5 represents average performance, and 1.0 represents exceptional performance), between −1 and 1 (e.g., −1.0 represents poor performance, 0.0 represents average performance, and 1.0 represents exceptional performance), a binary value (e.g., yes or no to a raise, a bonus, or the like), or the like. The fractional numbers may of course be scaled to be a percentage from 0 to 100, from 0 to 10, or other scale.

Data may be gathered from multiple locations (e.g., websites, databases, servers, or the like) in which individuals perform activities. For example, for software-related activities, the locations may include software databases with version control (e.g., referred to as development operations or DevOps), project management databases, and the like, such as, for example, GitLab, GitHub, Azure DevOps Server (formerly Team Foundation Server (TFS)), Apache Subversion (SVN), Jenkins, TeamCity, Octopus, Pivotal Tracker, Jira, ServiceNow, and the like. The data may include a number of incidents caused by individual developers in a particular time period, a number of changes performed by individual developers in a particular time period, logs generated as a result of changes made by individual developers in a particular time period, how many lines of code were committed in a particular time period, how many days a project is ahead of or behind schedule, and other metrics related to software development. Committing code means that the developer, after testing, makes the code available for inclusion in a software release. The data may include internal awards, stack ranking (e.g., ranking developers on a curve according to performance), peer recognition (e.g., nominated by peers for awards), patent application filings, and the like. GitLab provides various functionality, including project planning and source code management to code implementation, code development, and monitoring, in a single application. GitHub provides hosting for software development including distributed version control and source code management functionality. SVN is a software versioning and revision control system that is used to maintain current and historical versions of files such as source code, web pages, and documentation. Jenkins is an automation server which enables developers to reliably build, test, and deploy software. TeamCity is a build management and continuous integration server. Octopus manages releases, automates application deployment, and automates operational tasks. Pivotal Tracker provides project management for software releases. Jira provides issue (e.g., including bugs) tracking and project management. ServiceNow provides information technology (IT) Service Management (ITSM) and IT Business Management (ITBM), including incident management and problem management. Of course, the locations from which data is gathered may be based on individual job functions/titles and associated activities.

The data may be filtered to identify individual data associated with an individual developer. The data may be further filtered using various criteria (e.g., job function) to identify metrics used to gauge performance. For example, for a particular developer, the metrics may include a number of incidents caused by the particular developer in a particular time period, a number of changes performed by the particular developer in the particular time period, logs generated as a result of changes made by the particular developer in the particular time period, how many lines of code were committed in the particular time period, how many days a project is ahead of or behind schedule, and the like. In some cases, each metric may have a corresponding weight. For example, customer facing roles may have a higher weight for customer service than non-customer facing roles. The weighted metrics may be used as input into a first machine learning algorithm, such as an artificial neural network (ANN), and the result of the ANN may be normalized (e.g., to a value between 0 and 1, between −1 and +1, yes or no, or the like) using second machine learning algorithm, such as a logistic sigmoid (LS).

Some of the types of predictions that the ANN+LS can provide include answering questions, such as, for example, “Is this individual likely to leave (e.g., because the individual is not being rewarded properly)?” “Is this individual being properly compensated in terms of salary compared to peers making a similar contribution?” “Where does this individual rank within my group?” “Where does this individual rank among others having a same or similar job function under the same Director or Vice President (VP)?” “Should this individual be promoted?” “How much should this individual's salary be increased (e.g., given the allotted budget, the individual's ranking among peers, etc.?” and the like. In some cases, a manager may ask multiple questions and the data may be filtered and processed using the ANN+LS multiple times to answer each of the multiple questions. For example, the criteria used to filter the data may vary based on the question that is being answered. In addition, the ANN+LS may provide a manager with detailed information about each individual's contribution along with the recommendations, e.g., the ANN+LS may recommend that a first individual be given a first raise and a second individual be given a second raise that is less than the first raise and provide the reasoning why, e.g., the first individual did X (e.g., committed more lines of code, committed code that resulted in fewer errors, project was more difficult and/or of greater importance to the organization, or the like), the first individual completed a first project faster than the second individual completed a second project, another reason, or any combination thereof. In this way, a manager is provided a quantitative analysis as to why each individual should be compensated in a particular way. In this way, the influence of manager's subjective biases on the individual's evaluation may be reduced. While the examples used herein illustrate the use of ANN+LS to evaluate software developers, the systems and techniques may be applied equally to other types of individuals by adjusting the locations where data is gathered, the type of data that is gathered, and the filter criteria.

As an example, a computing device may include one or more processors and one or more non-transitory computer-readable media storing instructions that are executable by the one or more processors to perform various operations. For example, the operations may include determining activities to be monitored at multiple locations including at least a first location and a second location. Individual locations of the multiple locations may host a code repository that provides version control. For example, the code repository may include at least one of: GitLab, GitHub, Azure DevOps Server, Apache Subversion (SVN), Jenkins, TeamCity, Octopus, Pivotal Tracker, Jira, or ServiceNow. The activities may be performed by a plurality of individuals in an organization. The operations may include sending a first instruction to a first data monitor application to monitor the activities at the first location and sending a second instruction to a second data monitor application to monitor the activities at the second location. The operations may include receiving first data gathered by the first data monitor application over a predetermined amount of time. For example, the first data may include first activities performed by a first subset of the plurality of individuals. The operations may include receiving second data gathered by the second data monitor application over the predetermined amount of time. For example, the second data may include second activities performed by a second subset of the plurality of individuals. The operations may include filtering, based on one or more criteria, the first data and the second data to create filtered data and performing an analysis of the filtered data using a machine learning algorithm. The one or more criteria may be selected based at least in part on a job function associated with the particular individual. The one or more criteria may include, for the particular individual in a predetermined time period (e.g., one quarter, one year, or the like): how many lines of code are committed, a difference between a deadline associated with the code and a time the code was committed, how many issues are caused by the code, an amount time taken to resolve each issue caused by the code, how frequently the code is committed to a master branch, how many builds are completed, a success rate of completed builds, a percentage of code the particular individual contributed to a master branch, and a success rate of each commit. For example, the machine learning algorithm may include an artificial neural network and a logistic sigmoid function. The operations may include creating, based on the analysis, a human resource evaluation of a particular individual of the plurality of individuals. For example, the human resources evaluation may include a compensation recommendation. For example, the compensation recommendation may include at least one of: providing an increase in salary, providing a bonus, or providing a promotion. The human resources evaluation may include a probability that the particular individual will leave a current job in the organization.

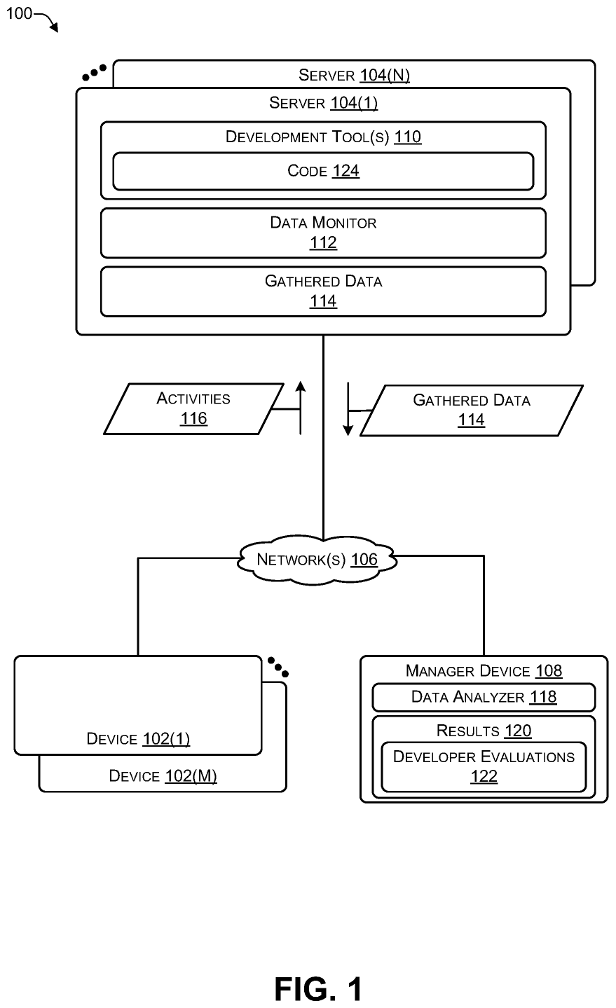

FIG. 1 is a block diagram of a system 100 that includes a manager device that uses machine learning to evaluate a performance of individuals (e.g., software developers), according to some embodiments. The system 100 includes multiple devices 102(1) to 102(M) (M>0) that are connected to multiple servers 104(1) to 104(N) (N>0) via one or more networks 106. individuals, such as software developers, may use the devices 102 to access applications and data hosted by the servers 104.

A manager device 108 may be connected to the servers 104 (e.g., information handling systems) via the network 106. The developer devices 102 and the manager device 108 may be computing devices, such as information handling systems. In this example, the servers 104 are the locations whether individuals perform various activities 116.

The developer devices 102 may be used by individuals to perform the activities 116, e.g., create, modify, and delete code 124 (e.g., stored on one or more of the servers 104). The code 124 may include software instructions written in a computer language. The activities 116 may include creating code, testing code, modifying code, deleting code, committing code to a particular release or branch, opening an issue, closing an issues, how long each issue was active, submitting a pull request (e.g., requesting that someone review and approve code changes before the changes become final), and other code related activities. For example, a developer may perform the activities 116 using one or more development tools 110 hosted by the servers 104, such as, for example, GitLab, GitHub, Azure DevOps Server (formerly Team Foundation Server (TFS)), Apache Subversion (SVN), Jenkins, TeamCity, Octopus, Pivotal Tracker, Jira, ServiceNow, other development tools, or any combination thereof. In some cases, each of the servers 104 may host a different one of the development tools 110.

A data monitor 112 may monitor the activities 116 to gather data to create gathered data 114. For example, the data monitor 112 may monitor the activities 116 performed using the development tools 110 to create the gathered data 114. The gathered data 114 may include, for example, in a particular time period (e.g., one day, one week, one month, or the like): a number of incidents caused by individual developers, a number of changes performed by individual developers, logs generated as a result of changes made, how many lines of code were committed, how many days a project is ahead of or behind schedule, who is creating the most issues, who is closing the most issues, who is doing the most commits, who is working on which projects, how many lines of code (e.g., how much per day) each developer is producing, and other metrics related to software development. Of course, for individuals having a different job function, the activities may be different. For commits, the gathered data 114 may include how many builds were kicked off, what was a success rate of the builds, how often does a developer commit to a master branch (e.g., which goes into production), what percentage of code that went into a master branch was a particular individual's contribution, a success rate of each commit, if a commit causes the master branch to break (e.g., have issues) then what is a time to resolve the issue (e.g., interval between error found and error resolved), number of meetings attended, number of emails sent, and the like. A commit may automatically cause various automated activities to take place, such as, for example, building a software release, publishing a software package, testing of code using automated test cases, and the like. The gathered data 114 may thus include various activities in which the developer participated.

In some cases, the gathered data 114 may be retrieved (e.g., “pulled”) periodically (at a predetermined time interval) by the manager device 108, while in other cases, the data monitor 112 may periodically send (e.g., “push”) the gathered data 114 to the manager device 108. Different trigger events may causes the gathered data 144 to be retrieved and/or sent to the manager device 108. For example, the trigger events may include a change in role or job title, a promotion, a time of the year (e.g., end of quarter, end of calendar year, end of fiscal year, or the like), and so on. The manager device 108 may use a data analyzer 118 to analyze the gathered data 114 to produce results 120 that include developer evaluations 122. For example, the data analyzer 118 may use an artificial neural network, and in some cases, a logistic sigmoid function, to create the developer evaluations 122. The gathered data 114 is related to each individual's job function. For example, for software developers, source control systems (e.g., GIT, SVN, and the like) are one source of data as such systems can track individual contributions down to a granular level (e.g., number of lines/characters added). The gathered data 114 may include a success of software deployments (e.g., measured in terms of issues), results of automated jobs from continuous integration (CI) systems (e.g., that continuously integrate committed code into a software release), test results, and code quality data associated with individual contributors. The gathered data 114 may include software development activity, production support tickets, documentation tasks (e.g., SharePoint, Confluence, or the like), communication metrics (e.g., Slack, Outlook, or the like). Thus, the gathered data 114 may include data that is related to activities performed by an individual and/or a team as part of their job function.

The gathered data 114 may be cross-analyzed with organizational data (e.g., Active Directory) to create customized reports of direct reports for managers, on an “on demand” basis (e.g., localized reports to a manager's organization). Such reports have a high value for an organization, as such reports provide an analysis of a manager's direct reports without the manager having to time to collect and analyze the data. The gathered data 114 may be analyzed using time boxing, stack ranking, and the like to identify individual metrics to assist the manager when performing performance reviews (e.g., quarterly or yearly). Furthermore, such an analysis of the gathered data 114 enables the manager to quickly identify a highest 5% or 10% (or other percentage) contributors in different areas (e.g., software coding, support, documentation, testing, and the like) by software release or by time interval (e.g., yearly, quarterly or the like). The data analyzer 118 may compare each individual's pay against the objective contributions (e.g., determined using the gathered data 114) to answer questions such as, “Are the top performers being properly compensated?” In this way, individuals contributing more (e.g., 5%, 10%, or 20% or more) than their peers in the same pay band may be identified and their compensation adjusted to more accurately reflect each individual's contribution relative to their peers. In addition, the manager can quickly identify bottom tier performers that might have previously (e.g., without such reports based on the gathered data 114) remained hidden.

Therefore, multiple individuals (e.g., software developers) may each use corresponding devices to perform various activities at various locations (e.g., access code stored on one or more servers). In the case of the software developers, the servers may host various development tools that enable the code to be added and managed, including providing version control and project management. A data monitor on each server may monitor the activities of each individual and gather data associated with the activities. A manager may use a manager device to retrieve or receive the gathered data from the servers. The manager device may include a machine learning algorithm, such as, for example, an artificial neural network, to process the gathered data to create developer evaluations based on the gathered data. The machine learning may be used to evaluate a large number of performance metrics while reducing “noise” (e.g., data not relevant to a developer's performance). In this way, the manager can evaluate individuals (e.g., software developers) based on the activities each individual performs. For example, software developers may be evaluated based on how much code they of contributed, how many issues they have caused, how many issues they of closed how quickly they have made each contribution, and the like. Thus, the individual evaluations may be data-driven evaluations that are less subjective than traditional evaluations.

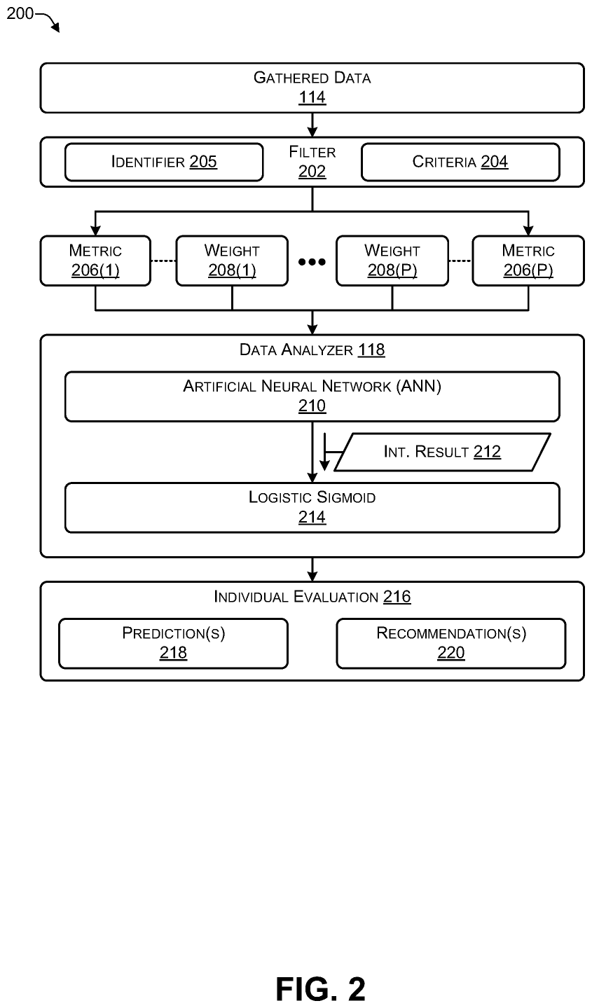

FIG. 2 is a block diagram of a system 200 to process gathered data using an artificial neural network and logistic sigmoid to create a performance evaluation, according to some embodiments. The system 200 illustrates how the gathered data 114 may be processed by the data analyzer 118 to produce an individual evaluation (e.g., one of the developer evaluations 122 of FIG. 1) for a particular individual.

The gathered data 114 may be filtered using a filter 202. The filter 202 may include multiple criteria 204, including a unique identifier 205 (e.g., name, employee identifier, or other unique identifier), and other criteria selected based on the identifier 205. For example, the criteria 204 may include criteria selected based on a job function associated with the individual that has the identifier 205. The identifier 205 may be used to filter out data associated with other individuals (e.g., data that is unassociated with the individual having the identifier 205). For example, an identifier who has a job function that includes customer facing activities may have criteria 204 to filter the gathered data 114 to include customer interaction related data. A team leader or supervisor may have criteria 204 to filter the gathered data 114 to include data associated with the team (e.g., being led by the team leader) or the person(s) being supervised. Thus, the criteria 204 may be used to filter the gathered data 114 to include data that is to be considered when evaluating the performance of a particular identifier while excluding other data that is not to be considered when evaluating the performance of the particular identifier.

The result of using the filter 202 on the gathered data 114 may be multiple metrics 206(1) to 206(P) (P>0), such as, for example (e.g., in the case of software developers), a number of issues caused by individual developers, a number of changes performed by individual developers, logs generated as a result of changes made, how many lines of code were committed, how many days a project is ahead of or behind schedule, and the like. In some cases, each of the metrics 206 may have a corresponding weight. For example, the metric 206(1) may have a weight 208(1) and the metric 206(P) may have a weight 208(P). The weights 208 may be selected based on the criteria 204. For example, the weights 208 may be selected based on a job function associated with the identifier 205. For example, the number of issues caused by a commit may have a larger weight for senior developers as compared to junior developers because senior developers may be expected to produce cleaner code (e.g., code with fewer issues) as compared to junior developers. As another example, the average time to resolve each issue may be weighted higher for senior developers as compared to junior developers because senior developers are expected to be able to resolve issues faster than junior developers.

The metrics 206 may be used as input to the data analyzer 118. The data analyzer 118 may include an artificial neural network 210 that produces an intermediate result 212. In some cases, the ANN 210 may select and continually modify (e.g., as part of the learning process) the weights 208 to refine the evaluation process. The intermediate result 212 may be arranged from −1 to +1, from zero to 1, or the like. The logistic sigmoid 214 may take the intermediate result 212 as input and output a binary result, such as to whether the employee receives a raise, receives a promotion, is in danger of leaving the department, or the like.

The logistic sigmoid 214 may have an equation:

f(x)=L÷(1+e^{-k(x-x0)})

where:
e is the natural logarithm base (e.g., Euler's number),
x0 is the x value of the sigmoid's midpoint,
L=the curve's maximum value, and
k=the logistic growth rate of the curve.

The logistic sigmoid 214 may take the intermediate result 212 and provide an individual evaluation 216 that includes one or more predictions 218 and/or one or more recommendations 220. For example, the predictions 218 and/or the recommendations 220 may be binary values such as, for example, this employee is predicted to leave his job within the next six months, this employee is recommended (or not recommended) to get a promotion, this employee is recommended to receive (or not receive) a raise. For example, the logistic sigmoid 214 may place the various intermediate results 212 for each developer on an S-curve to create a relative ranking of a developer with other developers in the developer's peer group.

The ANN 210 may use a type of supervised learning to make accurate predictions. The ANN 210 may learn to perform tasks by considering examples, generally without being programmed with task-specific rules. For example, the ANN 210 may automatically generate identifying characteristics from processing the examples. The ANN 210 may include a collection of connected units or nodes called artificial neurons, which loosely model the neurons in a biological brain. Each connection, like the synapses in a biological brain, may transmit a signal to other neurons. An artificial neuron that receives a signal may process the signal and signal other neurons connected to the artificial neuron. The signal may be a real number, and the output of each neuron may be computed by a non-linear function of the sum of its inputs. The connections between neurons are called edges. Neurons and edges may use the weights 208 and adjust the weights 208 during a continuous learning process. For example, each of the weights 208 may increase or decrease the strength of the signal at each connection. Neurons may have a threshold, such that a signal is sent only if the aggregate signal crosses the threshold. In some cases, neurons may be aggregated into layers. Different layers may perform different transformations on their inputs. Signals may travel from a first layer (e.g., an input layer), to a last layer (e.g., an output layer), possibly after traversing the layers multiple times.

The input variables to the ANN 210 may include an employee's knowledge of the job, a quality of the work, a quantity of the work, problem-solving and decision-making, teamwork and cooperation, leadership, rate of absenteeism in a given time period (e.g. per month), late attendance, communication skills, time management skills, adaptability and flexibility, professional attitude, initiatives undertaken, innovations (e.g., patent applications) submitted, dependability, confidence, steadiness under pressure, ethics and integrity, planning and capability, versatility, last time the individual had a pay raise, experience, pay band, actual pay, area of specialization, department, educational background, performance, team performance, service line, previous year's performance, highest education level, job title, management level in a corporate hierarchy, how much of the job function is a client facing role, whether travel is required, and other data related to work quality, work quantity, and work efficiency. Note that some types of input variables, such as, for example, gender, ethnicity, age, and the like may not be used in order to provide a “level playing field”. In this way, the metrics associated with an individual may be compared with metrics associated with other individuals without taking into account gender, ethnicity, age, and the like, resulting in a purely metric-based comparison.

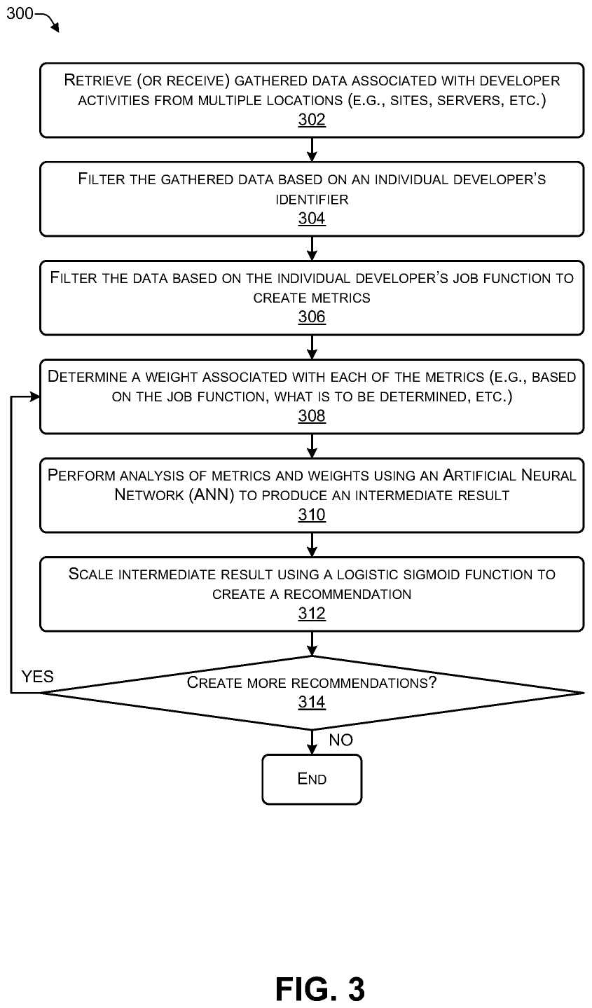

In the flow diagram of FIG. 3, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. For discussion purposes, the process 300 is described with reference to FIGS. 1 and 2 as described above, although other models, frameworks, systems and environments may be used to implement these processes.

FIG. 3 is a flowchart of a process 300 that includes performing an analysis of metrics and weights using an artificial neural network, according to some embodiments. The process 300 may be performed by the data analyzer 118 of FIGS. 1 and 2.

At 302, the process may retrieve or receive gathered data associated with individual activities from multiple locations. For example, in FIG. 1, the manager device 108 may receive or retrieve the gathered data 114 from multiple locations, such as the servers 104.

At 304, the process may filter the gathered data based on an individual's identifier. At 306, the process may filter the data based on the individual's job function/title to create metrics. At 308, the process may determine (e.g. based on the job function/title of the individual) a weight associated with each of the metrics. For example, in FIG. 2, the gathered data 114 may be filtered using the filter 202, including the identifier 205 and criteria 204. The weights 208 may be selected based on the identifier 205, such as a job title or job function associated with the identifier 205.

At 310, the process may use an artificial neural network to analyze the metrics and weights to produce an intermediate result. At 312, the process may use a logistic sigmoid function to scale the intermediate result to create a recommendation. For example, in FIG. 2, the artificial neural network 210 may receive as input the metrics 206 filtered from the gathered data 114 and the weights 208 selected based on the identifier 205 and output an intermediate result 212. The intermediate result 212 may be arranged from −1 to +1, from 0 to +1, or another type of range. The logistic sigmoid 214 may place the intermediate result 212 on an S-curve to create a binary result, such as whether the individual should receive a raise, whether the individual should receive a bonus, whether the individual should receive an award, whether the individual should receive a promotion, whether the individual is predicted to leave because the individual is not being properly compensate and/or recognized for their contribution, and other predictions 218 and/or recommendations 220.

At 314, the process may determine whether more recommendations are to be created. If the process determines, at 314, that more recommendations are to be created, then the process may proceed to 308 to determine a weight associated with each of the metrics. In this way, the process may repeat 308, 310, and 312 until one or more recommendations have been created. If a determination is made, at 314, that the one or more requested recommendations have been made, then the process may end. The process may repeatedly apply the filter 202 to the gathered data 114 to identify the metrics 206, apply the weights 208, and use the data analyzer 118 to determine multiple recommendations 220 and/or predictions 218 until the predictions and/or recommendations requested by the manager have been created. For example, a manager may ask the data analyzer 118 to answer various questions, such as whether an individual should receive a raise, how much of a raise the individual should receive, whether their individual should receive a bonus, whether the individual should receive a promotion, or the like.

Thus, data gathered from multiple locations (e.g., code repositories that have tools to provide version control and project management) may be filtered to identify various metrics used to gauge the performance of an individual. Based on the individual's job function or job title, a weight may be selected and assigned to each of the metrics. An artificial neural network, a type of machine learning algorithm, may be used to process the metrics to determine an intermediate result. The intermediate result may be smoothed using a logistic sigmoid function to create a binary value that provides a recommendation as to whether to reward the individual based on the gathered data associated with the individual. In this way, the human resources evaluation process is data-driven and the artificial neural network is able to compare and rank each individual in a group relative to other individuals in the group. The data that is gathered may be repeatedly filtered and analyzed to answer questions, such as, “Which individual had the most source code contributions in the release XYZ, where XYZ involved 10 different repositories and 100 individuals?”, “Which individual handled the most customer support tickets for my team in the second quarter?”, “Are there any trends in production incidents or code quality scores related to specific individuals?”, “What is my organizations cost per software release? Cost per commit? Cost per support ticket?”, “Are my top N performers being compensated commensurate with their contributions to the team?”, “Is my team performing with ace efficiency per dollar that is similar to other teams having similar roles in my organization?”, and the like. For example, a first set of filters may be used to answer a first question posed by the manager, a second set of filters may be used to answer a second question posed by the manager, and so on. In some cases, the manager may pose multiple questions and natural language processing (NLP) may be used to process the questions to create the different sets of filters.

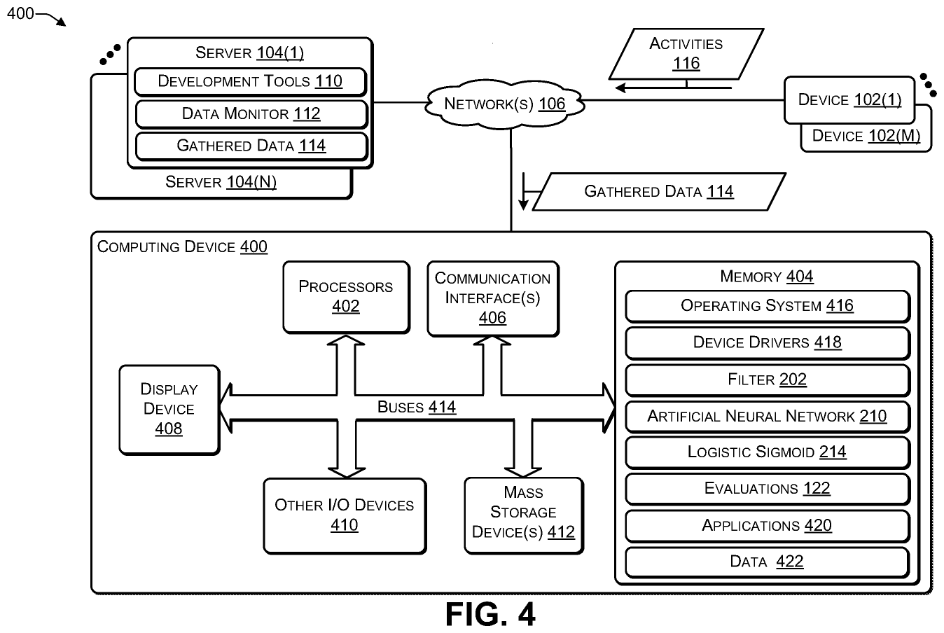

FIG. 4 illustrates an example configuration of a computing device 400 that can be used to implement the systems and techniques described herein, such as for example, the devices 102, the servers 104, and/or the device 108 of FIG. 1. For illustration purposes, the computing device 400 is shown as implementing the device 108 of FIG. 1.

The computing device 400 may include one or more processors 402 (e.g., including a central processing unit (CPU), a graphics processing unit (GPU), or the like), a memory 404, communication interfaces 406, a display device 408, other input/output (I/O) devices 410 (e.g., a keyboard, a trackball, and the like), and one or more mass storage devices 412 (e.g., disk drive, solid state disk drive, or the like), configured to communicate with each other, such as via one or more system buses 414 or other suitable connections. While a single system bus 414 is illustrated for ease of understanding, it should be understood that the system buses 414 may include multiple buses, such as a memory device bus, a storage device bus (e.g., serial ATA (SATA) and the like), data buses (e.g., universal serial bus (USB) and the like), video signal buses (e.g., ThunderBolt®, DVI, HDMI, and the like), power buses, etc.

The processors 402 are one or more hardware devices that may include a single processing unit or a number of processing units, all of which may include single or multiple computing units or multiple cores. The processors 402 may include a graphics processing unit (GPU) that is integrated with a CPU or the GPU may be a separate processor device from the CPU. The processors 402 may be implemented as one or more microprocessors, microcomputers, microcontrollers, digital signal processors, central processing units, graphics processing units, state machines, logic circuitries, and/or any devices that manipulate signals based on operational instructions. Among other capabilities, the processors 402 may be configured to fetch and execute computer-readable instructions stored in the memory 404, mass storage devices 412, or other computer-readable media.

Memory 404 and mass storage devices 412 are examples of computer storage media (e.g., memory storage devices) for storing instructions that can be executed by the processors 402 to perform the various functions described herein. For example, memory 404 may include both volatile memory and non-volatile memory (e.g., RAM, ROM, or the like) devices. Further, mass storage devices 412 may include hard disk drives, solid-state drives, removable media, including external and removable drives, memory cards, flash memory, floppy disks, optical disks (e.g., CD, DVD), a storage array, a network attached storage, a storage area network, or the like. Both memory 404 and mass storage devices 412 may be collectively referred to as memory or computer storage media herein and may be any type of non-transitory media capable of storing computer-readable, processor-executable program instructions as computer program code that can be executed by the processors 402 as a particular machine configured for carrying out the operations and functions described in the implementations herein.

The computing device 400 may include one or more communication interfaces 406 for exchanging data via the network 106. The communication interfaces 406 can facilitate communications within a wide variety of networks and protocol types, including wired networks (e.g., Ethernet, DOCSIS, DSL, Fiber, USB etc.) and wireless networks (e.g., WLAN, GSM, CDMA, 802.11, Bluetooth, Wireless USB, ZigBee, cellular, satellite, etc.), the Internet and the like. Communication interfaces 406 can also provide communication with external storage, such as a storage array, network attached storage, storage area network, cloud storage, or the like.

The display device 408 may be used for displaying content (e.g., information and images) to users. Other I/O devices 410 may be devices that receive various inputs from a user and provide various outputs to the user, and may include a keyboard, a touchpad, a mouse, a printer, audio input/output devices, and so forth.

The computer storage media, such as memory 404 and mass storage devices 412, may be used to store software and data. For example, the computer storage media may be used to store an operating system 416, device drivers 418, software applications 420, data 420, the filter 202, the ANN 210, the logistic sigmoid 214, and the evaluations 122.

Thus, multiple individuals (e.g., software developers) may each use corresponding devices 102 to perform various activities 116 at various locations (e.g., create and modify code stored on servers 104). In the case of the software developers, the servers 104 may host various development tools 110 that enable the code to be added and managed, including providing version control and project management. The data monitor 112 on each server 104 may monitor the activities 116 of each individual and gather data associated with the activities to create the gathered data 114. A manager may use a manager device (e.g., the computing device 400) to retrieve or receive the gathered data 114 from the servers 104. The manager device 102 may include a machine learning algorithm, such as, for example, the artificial neural network 210, to process the gathered data 114 to create the evaluations 122. The machine learning may be used to evaluate a large number of performance metrics. In this way, the manager can evaluate individuals (e.g., software developers) based on the activities 116 each individual performs. For example, software developers may be evaluated based on how much code they of contributed, how many issues they have caused, how many issues they of closed how quickly they have made each contribution, and the like. Thus, the individual evaluations may be data-driven evaluations that are less subjective than traditional evaluations.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A method comprising:
determining, by one or more processors, activities to be monitored at multiple locations comprising at least a first location and a second location, the activities performed by a plurality of individuals in an organization;
sending, by the one or more processors, a first instruction to a first data monitor application to monitor the activities at the first location;
sending, by the one or more processors, a second instruction to a second data monitor application to monitor the activities at the second location;
receiving, by the one or more processors, first data gathered by the first data monitor application over a predetermined amount of time, the first data including first activities performed by a first subset of the plurality of individuals;
receiving, by the one or more processors, second data gathered by the second data monitor application over the predetermined amount of time, the second data including second activities performed by a second subset of the plurality of individuals;
determining, by the one or more processors, one or more questions to be answered;
determining, by the one or more processors using natural language processing, one or more criteria based on the one or more questions;
filtering, by the one or more processors and based on the one or more criteria, the first data and the second data to create filtered data;
performing, by the one or more processors, an analysis of the filtered data using a machine learning algorithm; and
creating, by the one or more processors and based on the analysis, a human resource evaluation of a particular individual of the plurality of individuals, the human resources evaluation comprising a compensation recommendation.

2. The method of claim 1, wherein:
the machine learning algorithm comprises an artificial neural network and a logistic sigmoid function.

3. The method of claim 1, wherein:
the one or more criteria are selected based at least in part on a job function associated with the particular individual.

4. The method of claim 1, wherein individual locations of the multiple locations host a code repository that provides version control, the code repository comprising at least one of:
GitLab,
GitHub,
Azure DevOps Server,
Apache Subversion (SVN),
Jenkins,
TeamCity,
Octopus,
Pivotal Tracker,
Jira, or
ServiceNow.

5. The method of claim 1, wherein the activities comprise:
how many lines of code are committed;
a difference between a deadline associated with the code and a time the code was committed;
how many issues are caused by the code;
an amount time taken to resolve each issue caused by the code;
how frequently the code is committed to a master branch;
how many builds are completed;
a success rate of completed builds;
a percentage of code the particular individual contributed to a master branch; and
a success rate of each commit.

6. The method of claim 1, wherein the compensation recommendation comprises one of:
providing an increase in salary;
providing a bonus; or
providing a promotion.

7. The method of claim 1, wherein the human resources evaluation further comprises:
a prediction that the particular individual will leave a current job in the organization.

8. A computing device comprising:
one or more processors; and
one or more non-transitory computer-readable media storing instructions that are executable by the one or more processors to perform operations comprising:
determining activities to be monitored at multiple locations comprising at least a first location and a second location, the activities performed by a plurality of individuals in an organization;
sending a first instruction to a first data monitor application to monitor the activities at the first location;
sending a second instruction to a second data monitor application to monitor the activities at the second location;
receiving first data gathered by the first data monitor application over a predetermined amount of time, the first data including first activities performed by a first subset of the plurality of individuals;
receiving second data gathered by the second data monitor application over the predetermined amount of time, the second data including second activities performed by a second subset of the plurality of individuals;
filtering, based on one or more criteria, the first data and the second data to create filtered data;
performing an analysis of the filtered data using a machine learning algorithm; and
creating, based on the analysis, a human resource evaluation of a particular individual of the plurality of individuals, the human resources evaluation comprising a compensation recommendation.

9. The computing device of claim 8, wherein:
the machine learning algorithm comprises an artificial neural network and a logistic sigmoid function.

10. The computing device of claim 8, wherein:
the one or more criteria are selected based at least in part on a job function associated with the particular individual.

11. The computing device of claim 8, wherein individual locations of the multiple locations host a code repository that provides version control, the code repository comprising at least one of:
GitLab,
GitHub,
Azure DevOps Server,
Apache Subversion (SVN),
Jenkins,
TeamCity,
Octopus,
Pivotal Tracker,
Jira, or
ServiceNow.

12. The computing device of claim 8, wherein the criteria comprise, for the particular individual within the predetermined amount of time:
how many lines of code are committed;
a difference between a deadline associated with the code and a time the code was committed;
how many issues are caused by the code;
an amount time taken to resolve each issue caused by the code;
how frequently the code is committed to a master branch;
how many builds are completed;
a success rate of completed builds;
a percentage of code the particular individual contributed to a master branch; and
a success rate of each commit.

13. The computing device of claim 8, wherein the compensation recommendation comprises one of:
providing an increase in salary;
providing a bonus; or
providing a promotion.

14. The computing device of claim 8, wherein the human resources evaluation further comprises:
a probability that the particular individual will leave a current job in the organization.

15. One or more non-transitory computer-readable media storing instructions that are executable by one or more processors to perform operations comprising:
determining activities to be monitored at multiple locations comprising at least a first location and a second location, the activities performed by a plurality of individuals in an organization;
sending a first instruction to a first data monitor application to monitor the activities at the first location;
sending a second instruction to a second data monitor application to monitor the activities at the second location;
receiving first data gathered by the first data monitor application over a predetermined amount of time, the first data including first activities performed by a first subset of the plurality of individuals;
receiving second data gathered by the second data monitor application over the predetermined amount of time, the second data including second activities performed by a second subset of the plurality of individuals;
filtering, based on one or more criteria, the first data and the second data to create filtered data;
performing an analysis of the filtered data using a machine learning algorithm; and
creating, based on the analysis, a human resource evaluation of a particular individual of the plurality of individuals, the human resources evaluation comprising a compensation recommendation.

16. The one or more non-transitory computer-readable media of claim 15, wherein:
the machine learning algorithm comprises an artificial neural network and a logistic sigmoid function.

17. The one or more non-transitory computer-readable media of claim 15, wherein:
the one or more criteria are selected based at least in part on a job function associated with the particular individual.

18. The one or more non-transitory computer-readable media of claim 15, wherein individual locations of the multiple locations host a code repository that provides version control, the code repository comprising at least one of:
GitLab,
GitHub,
Azure DevOps Server,
Apache Subversion (SVN),
Jenkins,
TeamCity,
Octopus,
Pivotal Tracker,
Jira, or
ServiceNow.

19. The one or more non-transitory computer-readable media of claim 15, wherein the activities comprise:
how many lines of code are committed;
a difference between a deadline associated with the code and a time the code was committed;
how many issues are caused by the code;
an amount time taken to resolve each issue caused by the code;
how frequently the code is committed to a master branch;
how many builds are completed;
a success rate of completed builds;
a percentage of code the particular individual contributed to a master branch; and
a success rate of each commit.

20. The one or more non-transitory computer-readable media of claim 15, wherein:
the compensation recommendation comprises one of:
providing an increase in salary;
providing a bonus; or
providing a promotion; and
the human resources evaluation further comprises:
a probability that the particular individual will leave a current job in the organization.
